(19) United States
(12) Patent Application Publication
(10) Pub. No.: US 2024/0426237 A1
(43) Pub. Date: Dec. 26, 2024

(54) TANK

(71) Applicants: Ningbo Geely Automobile Research & Development Co., Ltd., Ningbo (CN); Zhejiang Geely Holding Group Co., Ltd., Zhejiang (CN)

(72) Inventors: Ulf BERGMAN, Torslanda (SE); Mikael JÖNSSON, Onsala (SE)

(21) Appl. No.: 18/823,215

(22) Filed: Sep. 3, 2024

Related U.S. Application Data
(63) Continuation of application No. PCT/CN2023/074207, filed on Feb. 2, 2023.

(30) Foreign Application Priority Data
Mar. 8, 2022 (EP) 22160926.6

(51) Int. Cl. F01P 11/02; F01P 11/14

(52) U.S. Cl. CPC F01P 11/029; F01P 11/14; F01P 2025/70

(57) ABSTRACT

A tank having a housing which provides a space for a liquid. An enclosure forming a sub space is arranged inside the housing at an upper part of the housing for trapping air when the liquid surface in the tank is inclined relative to the housing. An upper end of the enclosure is closed and airtight and a lower end of the enclosure is open connecting the space and the sub space fluidly to each other.

### RELATED APPLICATION DATA

This application is a continuation of International Patent Application No. PCT/CN2023/074207, filed Feb. 2, 2023, and claims the benefit of European Patent Application No. 22160926.6, filed Mar. 8, 2022, the disclosures of which are incorporated herein by reference in their entireties.

### TECHNICAL FIELD

The invention relates to a tank having a housing which provides a space for a liquid, and a vehicle comprising such a tank.

### BACKGROUND

A vehicle usually has a cooling system including a coolant expansion tank. Such a coolant expansion tank has a level sensor arranged to indicate the level of coolant, particularly when the level is low and additional coolant has to be filled into the cooling system.

If the vehicle is driven on a sloping road or is heavily accelerated, the surface of the coolant in the coolant expansion tank can however be inclined relative to the tank such that the level sensor wrongly indicates low level of coolant.

This means that the driver of the vehicle can receive false alarms indicating low level of coolant. The problem may occur for example when driving uphill or downhill, in a roundabout, during cornering or in case of heavy acceleration or deceleration.

### SUMMARY

An objective of the invention is to provide a tank, particularly for a vehicle, which tank can reduce the problem associated with an inclined liquid surface in the tank.

The objective is achieved by a tank having a housing which provides a space for a liquid, wherein an enclosure forming a sub space is arranged inside the housing at an upper part of the housing for trapping air when the liquid surface in the tank is inclined relative to the housing, and wherein an upper end of the enclosure is closed and airtight and a lower end of the enclosure is open connecting the space and the sub space fluidly to each other.

The invention is based on the insight that by such a tank, a higher level of liquid can be maintained in the tank when the liquid surface is inclined. In case of an inclined liquid surface, air will be trapped in the upper part of the sub space preventing liquid from filling the sub space which in turn results in a higher level of liquid in the space outside the sub space.

For example, in the case the tank has a level sensor indicating the level of liquid in the tank, which level sensor is arranged in the space outside the sub space, a higher level of liquid can be maintained at the position for the level sensor when the liquid surface is inclined, thereby avoiding false alarms.

The tank can be any container or limited space containing a liquid where access to the liquid is needed when the liquid level is low, such as a coolant tank, an oil sump of a combustion engine, transmission, etc., and not only when the level of liquid is to be measured. For example, in case the tank has a pump for pumping liquid out from the tank, an inlet of the pump can be arranged in the space outside the sub space for enabling pumping of liquid when the liquid surface is inclined.

According to a further embodiment of the tank, the tank is a coolant tank for a coolant system of a vehicle. The limited space available in an engine compartment of a vehicle often determines the shape of a coolant tank arranged in the engine compartment. The invention is advantageously applied for a coolant tank that is relatively flat (shallow) and/or oblong (long) since such a coolant tank is more sensitive to inclination of the liquid surface.

According to one embodiment of the tank, the enclosure comprises at least one wall extending inside the tank from an upper portion of the housing in a direction towards a lower portion of the housing. Hereby, the enclosure can be integrated in the housing and the tank can be produced in a rational way.

According to a further embodiment of the tank, the enclosure is a tube. Hereby, a cup-like enclosure providing the sub space can be achieved. The tube can have a cross section adapted to the shape of the tank. For example, the cross section can be quadrangular, such as rectangular, or the tube can have a circular cross section. The longitudinal extension direction of the tube, when the tank is horizontal, is preferably substantially vertical.

According to a further embodiment of the tank, a lower end of the tube is slanted, wherein the end surface of the lower end of the tube is inclined with an angle α relative to a horizontal plane such that the end surface slopes downwards in a direction towards a vertical centerline of the housing. Hereby, the efficiency of the sub space trapping air can be further increased. The angle α can be in the range 5°<α<50°, preferably in the range 10<α<45°.

According to a further embodiment of the tank, the enclosure is arranged at a distance from a side wall of the housing whereby a gap between the enclosure and the side wall is created in a horizontal direction. Hereby, it is secured that liquid can circulate and be collected in the space of the housing outside the enclosure when air is trapped in the sub space.

According to a further embodiment of the tank, the enclosure has a length in a vertical direction which length is less than the distance between a top wall of the housing and a bottom wall of the housing, and a gap is arranged between the enclosure and the bottom wall of the housing. Hereby, it is secured that the space and the sub space are fluidly connected to each other at the same time as the liquid can pass under the enclosure.

For example, the length of the enclosure in the vertical direction can be in a range of 0.3-0.9, preferably 0.5-0.8 times the distance between the top wall and the bottom wall of the housing.

According to a further embodiment, the tank has a plurality of said enclosure providing a plurality of said sub space. Hereby, the capacity to trap air can be further increased, and air can be trapped for different inclinations of the liquid surface.

According to a further embodiment of the tank, the enclosures are arranged at a distance from each other creating a gap between adjacent enclosures in a horizontal direction. Hereby, it is secured that liquid can circulate and be collected in the space of the housing outside the enclosures when air is trapped in the sub spaces.

The invention also relates to a vehicle comprising a tank according to the invention, particularly a coolant tank for a coolant system.

Further advantages and advantageous features of the invention are disclosed in the following description and in the claims.

### BRIEF DESCRIPTION OF THE DRAWINGS

With reference to the appended drawings, below follows a more detailed description of embodiments of the invention cited as examples.

In the drawings:

FIG. 1A is a schematic view showing a tank with liquid,

FIG. 1B is a cross section view taken along B-B in FIG. 1A,

FIG. 1C is a cross section view taken along B-B for a variant of the tank,

FIG. 2A shows the tank illustrated in FIG. 1A when the liquid surface is inclined by g-forces,

FIG. 2B shows the tank illustrated in FIG. 1A when the tank is inclined,

FIG. 3A is a perspective view showing the upper side of a coolant tank,

FIG. 3B is a perspective view showing the underside of the tank in FIG. 3A,

FIG. 4A shows an upper portion of the tank in FIG. 3A in a view from below,

FIG. 4B shows lower portion of the tank in FIG. 3A in a view from above,

FIG. 5 is a cut view of the tank in FIG. 3A, and

FIG. 6 shows a vehicle with a tank according to the invention.

### DETAILED DESCRIPTION OF EXAMPLE EMBODIMENTS

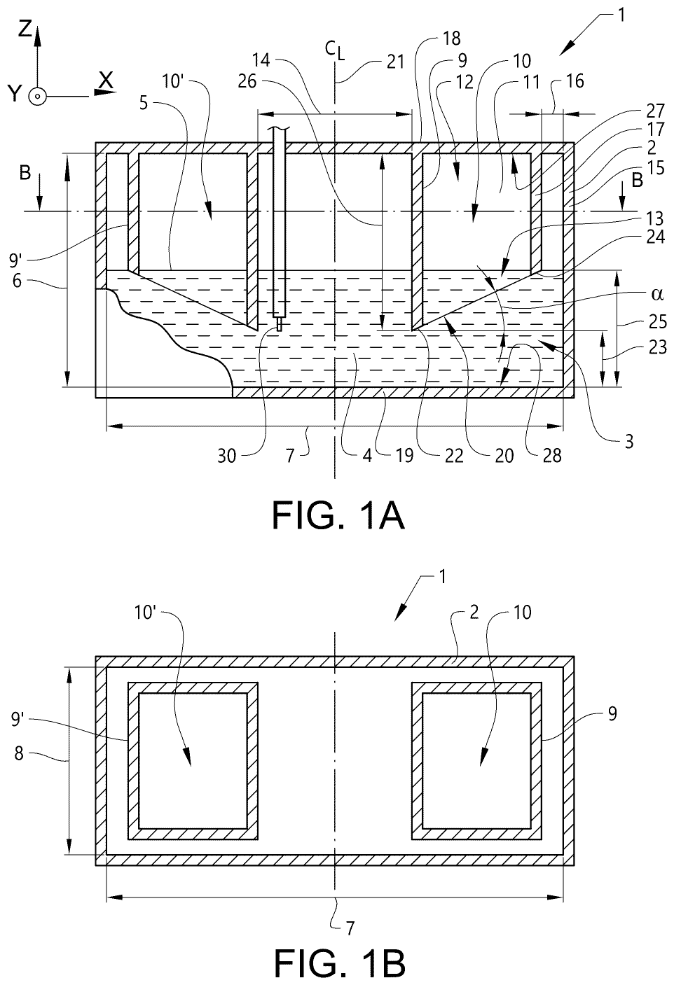

FIG. 1A shows a tank 1 in a schematic view, such as a cooling expansion tank for a vehicle. The tank 1 has a housing 2 which provides a space 3 for a liquid 4, such as a coolant. As an example, and for illustration purposes, in FIG. 1A, the tank 1 is partly cut and approximately half filled with the liquid 4 which is indicated with dashed lines.

In FIG. 1A, the tank 1 is arranged horizontally and the liquid surface 5 is also horizontal. This is the case for example when the tank 1 is installed in a vehicle standing on level ground. See also a Cartesian coordinate system X, Y, Z, where all axes are orthogonal to each other, introduced for facilitating the description of the tank. The directions and axes used herein, i.e. the X-axis, Y-axis and the Z-axis, are arranged relative to the tank 1 such that when the tank 1 is horizontally arranged, the Z-axis is a vertical axis in parallel with a height 6 of the tank 1, the X-axis is a horizontal axis in parallel with a length 7 of the tank 1, and the Y-axis is a horizontal axis in parallel with a width 8 of the tank 1. When using “horizontal”, “vertical”, etc., herein, reference is made to this horizontal position of the tank as illustrated in FIG. 1A.

See also FIG. 1B showing the tank 1 in a cross section view from above taken along B-B in FIG. 1A.

The tank 1 further comprising an enclosure 9 arranged inside the housing 2. The enclosure 9 forms a sub space 10 at an upper part 11 of the housing 2 for trapping air when the liquid surface 5 in the tank 1 is inclined relative to the housing 2. An upper end 12 of the enclosure 9 is closed and airtight and a lower end 13 of the enclosure 9 is open connecting the space 3 and the sub space 10 fluidly to each other. The tank 1 may comprise a plurality of said enclosure 9 providing a plurality of said sub space 10. In the example embodiment illustrated in FIG. 1A, the tank 1 has two such enclosures 9, 9′ each providing a sub space 10, 10′. The enclosures 9, 9′ are arranged at a distance from each other creating a gap 14 between adjacent enclosures in the horizontal direction. Each enclosure 9 is arranged at a distance from a side wall 15 of the housing whereby a gap 16 between the enclosure 9 and the side wall 15 is created in a horizontal direction.

Each enclosure 9 comprises at least one wall 17 extending inside the tank 1 from an upper portion 18 of the housing 2 in a direction towards a lower portion 19 of the housing 2. The enclosure is suitably a tube 9, where the longitudinal extension direction of the tube is substantially vertical. The tube 9 is closed in the upper end 12 and open in the lower end 13.

As shown in FIG. 1B, the enclosures 9, 9′ defining the sub spaces 10, 10′ may have quadrangular cross sections, but other shapes are also possible.

FIG. 1C is a cross section view showing a variant of the tank where the enclosures 9, 9′ have circular cross sections.

Preferably, the lower end 13 of the tube 9 is slanted, such that the end surface 20 of the lower end 13 of the tube 9 is inclined with an angle α relative to a horizontal plane, and the end surface 20 slopes downwards in a direction towards a vertical centerline 21 of the housing 2. The horizontal plane is in parallel with the plane defined by the X-axis and the Y-axis. The vertical centerline 21 is in parallel with the Z-axis.

In other words; the end surface 20 of the lower end 13 of the tube 9 is inclined such that a part 22 of the end surface 20 arranged with the smallest distance 23 to the lower portion 19 is arranged closest to the vertical centerline 21 of the housing 2, and a part 24 of the end surface 20 arranged with the greatest distance 25 to the lower portion 19 is arranged furthest from the vertical centerline 21.

The enclosure 9 suitably has a length 26 in a vertical direction which length is less than the distance between a top wall 27 of the housing 2 and a bottom wall 28 of the housing 2, and a gap 23 is arranged between the enclosure 9 and the bottom wall 28 of the housing 2 in a vertical direction.

The tank may have a level sensor 30 indicating the level of liquid 4 in the tank 1. Such a level sensor 30 is arranged in the space 3 outside the sub space 10.

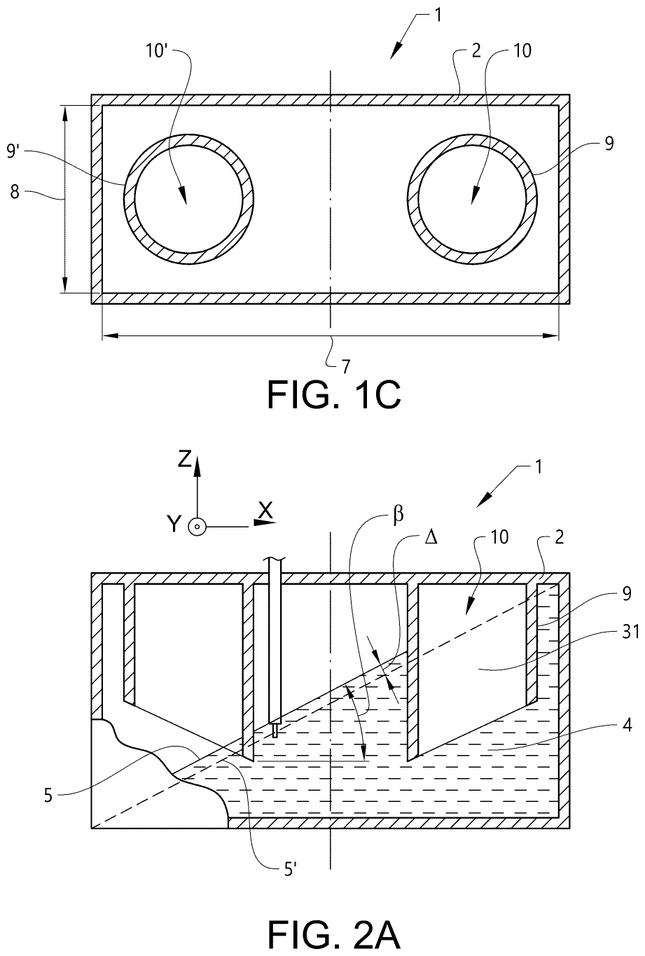

FIG. 2A shows the tank 1 illustrated in FIG. 1A when the liquid surface 5 is inclined relative to the horizontal housing 2. The liquid surface 5 is inclined with an angle β relative to the horizontal axis X. Such an inclination can arise due to acceleration or deceleration of the tank (i.e. due to g-forces), for example when the tank 1 is installed in a vehicle driving along a road.

The sub space 10 of the enclosure 9 to the right is filled with air 31 preventing liquid 4 from reaching the sub space 10. The actual liquid surface 5 is indicated with a solid line and further, a dotted line indicates the liquid surface 5′ or level that would have been present in case there was no enclosure trapping air. The increased level of liquid 4 due to the trapped air is the difference Δ between the solid line and the dotted line.

FIG. 2B shows the tank 1 illustrated in FIG. 1A when the tank 1 is inclined with an angle β relative to the horizontal axis X, whereas the liquid surface 5 is in parallel with the horizontal axis X. This means the liquid surface 5 is inclined with an angle β relative to the housing 2. Such an inclination of the tank 1 can arise when the tank 1 is installed in a vehicle driving along a sloping road.

In the same way as previously explained with reference to FIG. 2B, the sub space 10 of the enclosure 9 to the right is filled with air 31 preventing liquid 4 from reaching the sub space 10. The actual liquid surface 5 is indicated with a solid line and further a dotted line indicates the liquid surface 5′ or level that would have been present in case there was no enclosure trapping air. The increased level of liquid 4 due to the trapped air is the difference Δ between the solid line and the dotted line.

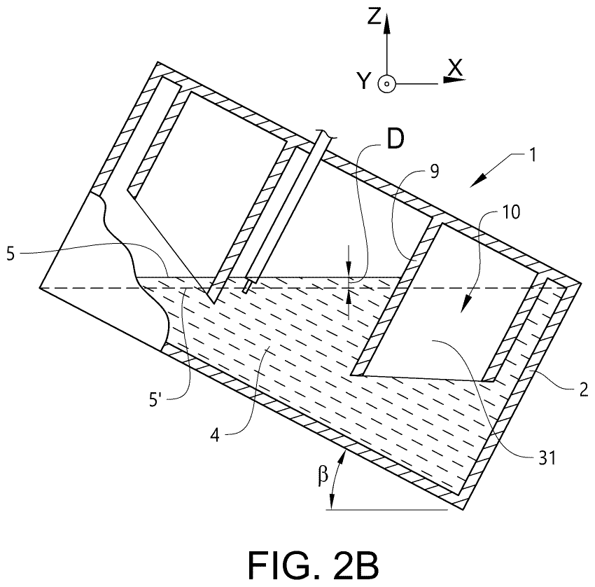

FIGS. 3A and 3B show in perspective views from above and below, respectively, a further example embodiment of the tank constituting a vehicle coolant expansion tank. Primarily, the features unique for this example embodiment are described. As it regards previously described features, reference is made to the description hereinabove. Further, same reference numerals have been used for similar or equal components.

The expansion coolant tank 1 is relatively flat (shallow) in comparison to the length (and width) of the tank. The limited space available in an engine compartment of a vehicle often determines the shape of a coolant tank arranged in the engine compartment. Such a shallow coolant tank can be more sensitive to inclination of the liquid surface resulting in false low coolant level warnings.

The housing 2 of the tank 1 can be made from an upper portion 18, such as a cap, and a lower portion 19, such as a container. The upper portion and lower portion refer to the orientation of the tank 1 when installed in a vehicle. As appears from FIG. 3A, the cap 18 has an opening 50 for filling of coolant into the tank 1. As appears from FIG. 3B, the container 19 has connections 51 for connecting the tank fluidly to a coolant system of a vehicle. Further, the tank 1 has brackets 52 for attachment of the tank 1 in the engine compartment.

The cap 18 and the container 19 are suitably provided with flanges 53, 54 for connecting the cap 18 and the container 19 to each other in a waterproof way, permanently or in a divisible way.

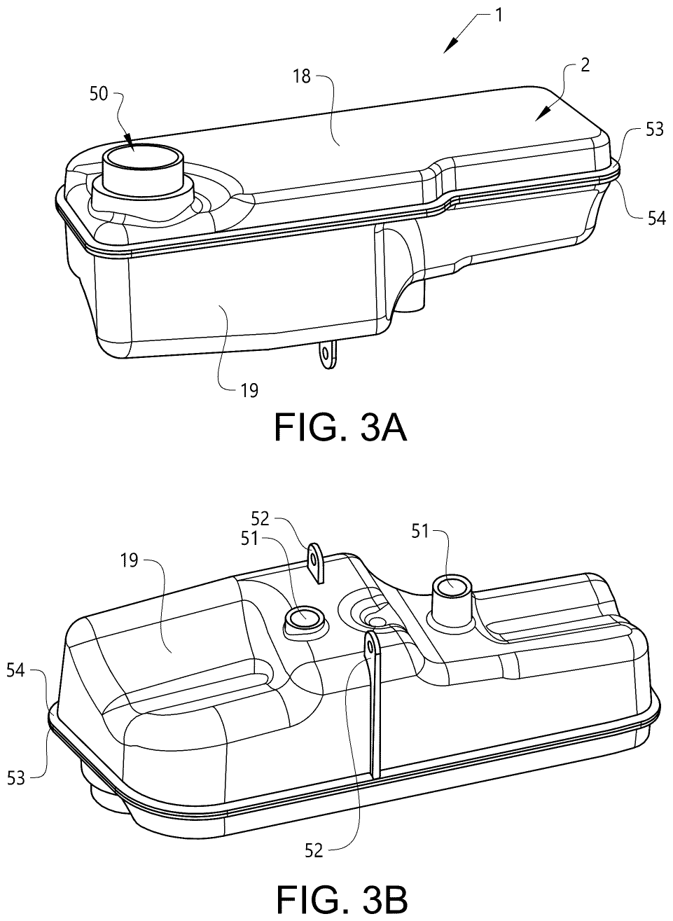

FIG. 4A shows the cap 18 from below. On the inside of the cap 18, walls 55 can be arranged to divide the housing 2 into several compartments 56 to counteract too fast transport and splash of coolant when the tank 1 is subjected to acceleration or deceleration. In such a case, some openings 57 have to be arranged in the walls 55 to enable coolant to flow, with a reduced speed instead, in the housing 2 which provides one continuous space for the coolant.

In the example embodiment illustrated in FIG. 4A, the tank 1 is provided with two enclosures 9 forming two sub spaces 10 in the tank 1. For the two compartments 56 to the right in FIG. 4A, one enclosure 9 is arranged in each compartment 56 for trapping air when the liquid surface in the tank 1 is inclined relative to the housing 2. Each enclosure 9 is designed as a tube extending from the cap 18 towards the container 19 when the cap and container are connected to each other.

FIG. 4B shows the container 19 from above. On the inside of the container 19, in the same way as previously described for the cap 18, walls 55′ can be arranged in the bottom of the container 19 to divide the housing 2 into the several compartments 56′ to counteract too fast transport and splash of coolant when the tank is subjected to acceleration or deceleration. The walls 55 of the cap 18 and the walls 55′ of the container 19 are suitably designed such that when the cap 18 and the container 19 are connected, a respective cap wall 55 and a respective container wall 55′ together form a complete wall corresponding to the height of the housing 2. In such a case, some openings 57 may have to be arranged in the container walls 55′ as well, allowing coolant to be transported with a reduced speed.

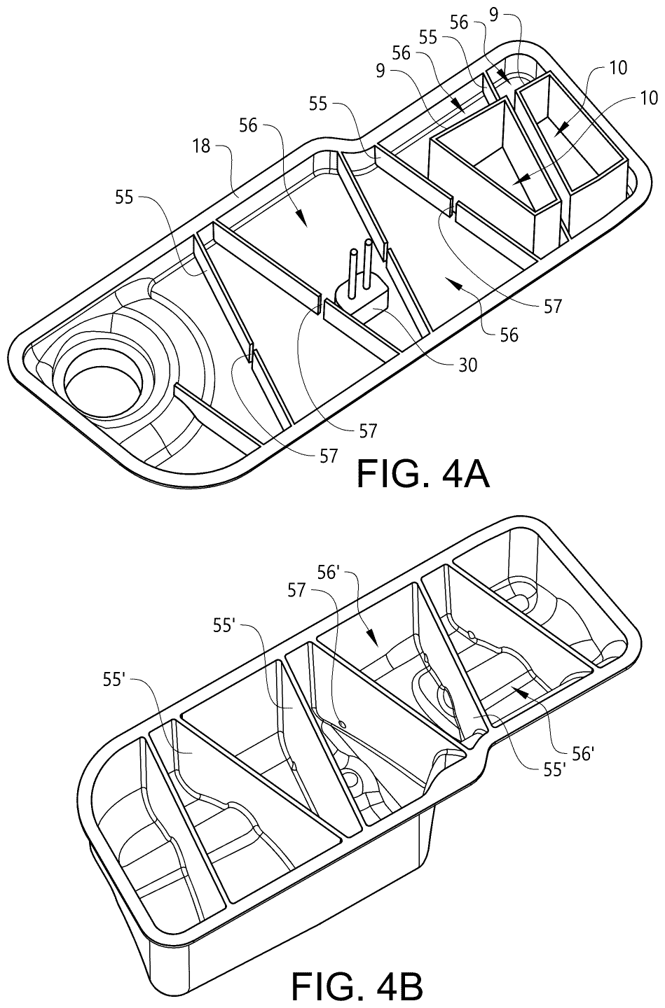

In the example embodiment illustrated in FIG. 4B, for the two compartments 56′ to the right, one enclosure 9 is received in each compartment 56′ when the cap 18 and the container 19 are connected to each other. See also FIG. 5.

FIG. 5 shows a cross section view of the tank 1 when the liquid surface 5 is inclined relative to the housing 2. The liquid surface 5 is inclined relative to the horizontal housing 2. The liquid surface 5 is inclined with an angle β relative to the horizontal axis X. Such an inclination can as already mentioned arise due to acceleration or deceleration of the tank 1 (i.e. due to g-forces), for example when the tank 1 is installed in a vehicle driving along a road. Since the sub space 10 of each enclosure 9 is filled with air 31 preventing liquid 4 from reaching the sub space 10, the level of liquid reaches the level sensor 30.

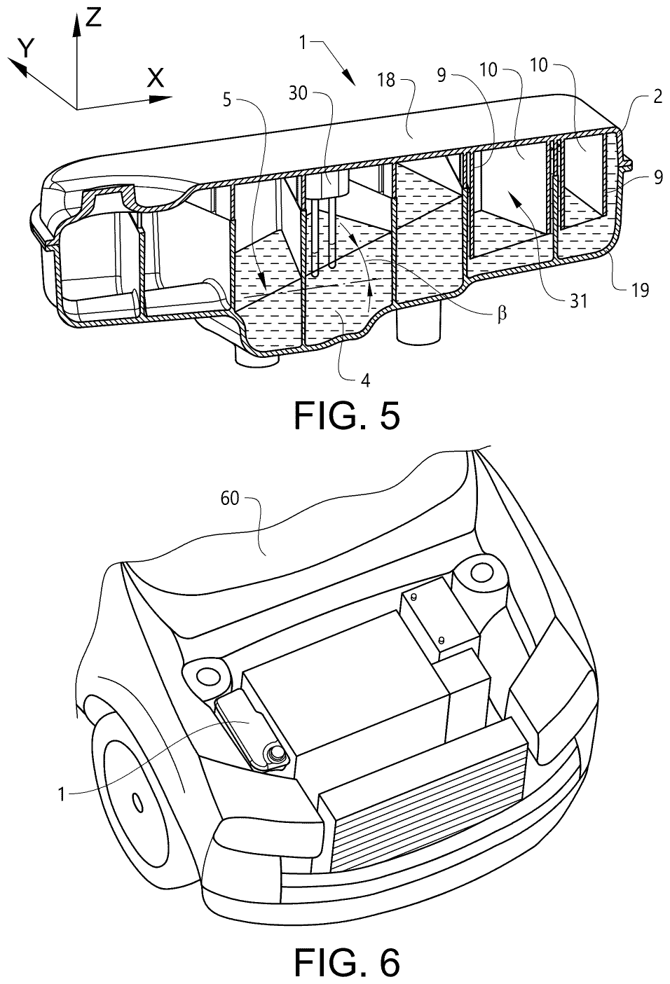

FIG. 6 shows a vehicle 60 provided with a tank 1 according to the invention used as an expansion coolant tank.

It is to be understood that the present invention is not limited to the embodiments described above and illustrated in the drawings; rather, the skilled person will recognize that many changes and modifications may be made within the scope of the appended claims.

What is claimed is:

1. A tank having a housing which provides a space for a liquid, wherein an enclosure forming a sub space is arranged inside the housing at an upper part of the housing for trapping air when the liquid surface in the tank is inclined relative to the housing, an upper end of the enclosure being closed and airtight and a lower end of the enclosure being open connecting the space and the sub space fluidly to each other, wherein the tank has a level sensor indicating the level of liquid in the tank, the level sensor being arranged in the space outside the sub space.

2. A tank according to claim 1, wherein the enclosure comprises at least one wall extending inside the tank from an upper portion of the housing in a direction towards a lower portion of the housing.

3. A tank according to claim 1, wherein the enclosure is a tube.

4. A tank according to claim 3, wherein the longitudinal extension direction of the tube is substantially vertical.

5. A tank according to claim 3, wherein a lower end of the tube is slanted, the end surface of the lower end of the tube being inclined with an angle relative to a horizontal plane such that the end surface slopes downwards in a direction towards a vertical centerline of the housing.

6. A tank according to claim 5, wherein the angle is in the range 5°-50°, preferably 10°-45°.

7. A tank according to claim 1, wherein the enclosure is arranged at a distance from a side wall of the housing whereby a gap between the enclosure and the side wall is created in a horizontal direction.

8. A tank according to claim 1, wherein the enclosure has a length in a vertical direction which length is less than the distance between a top wall of the housing and a bottom wall of the housing, and a gap is arranged between the enclosure and the bottom wall of the housing.

9. A tank according to claim 8, wherein the length of the enclosure in the vertical direction is in a range of 0.3-0.9, preferably 0.5-0.8 times the distance between the top wall and the bottom wall of the housing.

10. A tank according to claim 1, wherein the tank has a pump for pumping liquid out from the tank, an inlet of the pump being arranged in the space outside the sub space.

11. A tank according to claim 1, wherein the tank has a plurality of said enclosure providing a plurality of said sub space.

12. A tank according to claim 11, wherein the enclosures are arranged at a distance from each other creating a gap between adjacent enclosures in a horizontal direction.

13. A tank according to claim 1, wherein the tank is a coolant tank for a coolant system of a vehicle.

14. A vehicle comprising a tank according to claim 1.
